(19) United States
(12) Patent Application Publication
(10) Pub. No.: US 2025/0376326 A1
(43) Pub. Date: Dec. 11, 2025

(54) ROBOTIC CELL ASSEMBLY, ROBOTIC CELL, AND METHODS

(71) Applicant: PREMIER TECH TECHNOLOGIES LTEE, Rivière-du-Loup (CA)

(72) Inventors: Jeremy LIZANDIER, Rivière-du-Loup (CA); Olivier PATRY, Rivière-du-Loup (CA); Marc-Antoine LACASSE, Rivière-du-Loup (CA); Valerie LAVOIE, Rivière-du-Loup (CA)

(73) Assignee: PREMIER TECH TECHNOLOGIES LTEE, Rivière-du-Loup (CA)

(21) Appl. No.: 19/230,032

(22) Filed: Jun. 5, 2025

(30) Foreign Application Priority Data
Jun. 6, 2024 (CA) 3,240,671

(51) Int. Cl. B65G 1/137

(52) U.S. Cl. CPC B65G 1/137

(57) ABSTRACT

There is provided a robotic cell and a robotic cell assembly. The robotic cell includes: a robot support and transport frame, a casing mounted to the frame and defining a control chamber, a control unit and an electric panel contained in the control chamber, a robot base mounted to the frame and a robot mounted to the robot base and operatively connected to the control unit, and at least one connector port in communication with at least one of the robot, the control unit, and the electric panel. The robotic cell assembly can further include a transport and storage container defining a storage space and the robotic cell is contained in the storage space. There is also provided a method for storing and transporting the robotic cell and a method for displacing the robotic cell.

### CROSS-REFERENCE TO RELATED APPLICATIONS

This application claims priority of Canadian patent application no. 3.240.671 filed Jun. 6, 2024, the specification of which is hereby incorporated by reference.

### TECHNICAL FIELD OF THE INVENTION

The technical field relates to a robotic cell assembly in a configuration for storage and transportation and a robotic cell. It also refers to methods for storing, transporting, and displacing a robotic cell.

### BACKGROUND

Automated robotic cells, such as palletizing/grouping robotic cells, are typically designed to perform specific tasks and it may be difficult and time consuming to adapt the robotic cells to changes in warehouse layouts or product types. Furthermore, acquiring robotic cells can be expensive and it can take several months and specialists to design, manufacture, retrofit install and commission on-site.

Therefore, industrials may be reluctant to invest for a new robotic cell for some routinely tasks that can be easily performed by a robot but which are not carried out on a regular basis, on production lines having a lower throughtput, or on production lines for new product testing.

In view of the above, there is a need for a less expensive, easier to install, and/or faster to modify robotic cell which would be able to overcome or at least minimize some of the above-discussed prior art concerns.

### BRIEF SUMMARY OF THE INVENTION

It is therefore an aim of the present invention to address the above-mentioned issues.

According to a general aspect, there is provided a robotic cell assembly comprising: a transport and storage container defining a storage space; and a robotic cell contained in the storage space. The robotic cell comprises: a robot support and transport frame having a carrier floor; a casing mounted to the robot support and transport frame and defining a control chamber; a control unit contained in the control chamber; an electric panel contained in the control chamber; a robot base mounted to the robot support and transport frame and protruding upwardly therefrom; a robot mounted to the robot base and operatively connected to the control unit; and at least one connector port mounted to one of the robot support and transport frame and the casing and each one being in communication with at least one of the robot, the control unit, and the electric panel.

In an embodiment, the robot comprises a robot arm with a shoulder joint and the shoulder joint is at least one of highest component of the robot inside the storage space. The shoulder joint can be at least one of the highest component of the robotic cell inside the storage space.

In an embodiment, the carrier floor of the robot support and transport frame defines an upper surface and the robot support and transport frame further includes peripheral walls to space apart the carrier floor from a floor supporting the robot support and transport frame, wherein forklift tines are insertable in a spacing defined between the carrier floor and the floor and wherein the casing and the robot base protrude upwardly from the upper surface of the carrier floor. The robot support and transport frame can define forklift-fork receiving channels with the forklift tines being receivable therein.

In an embodiment, the at least one connector port of the robotic cell comprises a plurality of connector ports and the robot support and transport frame comprises at least one connector protection casing defining a connector protection channel and the robotic cell further comprises at least one electrical, hydraulic, optical, and/or pneumatic connectors extending at least partially inside the connector protection channel, at least one of the at least one electrical, hydraulic, optical, and pneumatic connectors being connected to a respective one of the connector ports. The at least one connector protection casing can extend below the carrier floor of the robot support and transport frame. The robot support and transport frame can comprise a connector port casing defining a connector port chamber, wherein the connector ports are contained at least partially inside and accessible from the connector port chamber.

In an embodiment, the robot support and transport frame comprises a conveyor attachment engageable with a conveyor to prevent relative displacement between the conveyor and the robotic cell.

In an embodiment, the robot support and transport frame comprises floor anchors.

In an embodiment, the robotic cell further comprises a HMI support mounted to at least one of the casing and the robot support and transport frame. The robotic cell can further comprise a human-machine interface (HMI) mounted to the HMI support.

According to another general aspect, there is provided a robotic cell comprising: a robot support and transport frame having a carrier floor; a casing mounted to the robot support and transport frame and defining a control chamber; a control unit contained in the control chamber; an electric panel contained in the control chamber; a robot base mounted to the robot support and transport frame and protruding upwardly therefrom; a robot mounted to the robot base and operatively connected to the control unit; and at least one connector port mounted to one of the robot support and transport frame and the casing and each one being in communication with at least one of the robot, the control unit, and the electric panel, wherein the robotic cell is displaceable as a single unit from one location to another by displacing the robot support and transport frame.

In an embodiment, the carrier floor of the robot support and transport frame defines an upper surface and the robot support and transport frame further includes peripheral walls to space apart the carrier floor from a floor supporting the robot support and transport frame, wherein forklift tines are insertable in a spacing defined between the carrier floor and the floor and wherein the casing and the robot base protrude upwardly from the upper surface of the carrier floor. The robot support and transport frame can define forklift-fork receiving channels with the forklift tines being receivable therein.

In an embodiment, the at least one connector port of the robotic cell comprises a plurality of connector ports and the robot support and transport frame comprises at least one connector protection casing defining a connector protection channel and the robotic cell further comprises at least one electrical, hydraulic, optical, and/or pneumatic connectors extending at least partially inside the connector protection channel, at least one of the at least one electrical, hydraulic, optical, and pneumatic connectors being connected to a respective one of the connector ports. The at least one connector protection casing can extend below the carrier floor of the robot support and transport frame.

In an embodiment, the robot support and transport frame comprises a connector port casing defining a connector port chamber, wherein the connector ports are contained at least partially inside and accessible from the connector port chamber.

In an embodiment, the robot support and transport frame comprises a conveyor attachment engageable with a conveyor to prevent relative displacement between the conveyor and the robotic cell.

In an embodiment, the robot support and transport frame comprises floor anchors.

In an embodiment, the robotic cell further comprises a HMI support mounted to at least one of the casing and the robot support and transport frame. The robotic cell can further comprise a human-machine interface (HMI) mounted to the HMI support.

According to a further general aspect, there is provided a method for storing and transporting the robotic cell as described above. The method comprises: folding a robot arm of the robot into a compacted storage configuration wherein a shoulder joint of the robot arm is at least one of highest component of the robot; inserting the robotic cell with the robot in the compacted storage configuration inside a storage space defined in the transport and storage container; and closing the transport and storage container.

According to still another general aspect, there is provided a method for displacing the robotic cell as described from a first location to a second location, comprising: at the first location, lifting the robot support and transport frame having the casing and the robot base mounted thereto, the robot being secured to the robot base, the HMI support and the at least one connector port being mounted to at least one of the casing and the robot support and transport frame, the control unit and the electric panel be contained in the control chamber of the casing, connectors extending between the at least one connector port and at least one of the robot, the control unit, and the electric panel, the robot being operatively connected to at least one of the control unit and the electric panel and the at least one connector port being ready to be in communication with at least one of the robot, the control unit, and the electric panel; displacing the lifted robot support and transport frame the second location; and setting down the lifted robot support and transport frame at the second location.

In an embodiment, before lifting the robot support and transport frame, at least one of: detaching a conveyor engaged with the robot support and transport frame; and unsecuring the robot support and transport frame from the floor.

In an embodiment, lifting comprises inserting forklift tines in a spacing defined between the carrier floor and a floor and raising the forklift tines to lift the robot support and transport frame.

### BRIEF DESCRIPTION OF THE DRAWINGS

FIG. 1 is a rear perspective view of a robotic cell with a conveyor and two pallets in accordance with an embodiment;

FIG. 2 is a side elevation view of the robotic cell of FIG. 1;

FIG. 3 is a rear perspective view of the robotic cell of FIG. 1, without the conveyor and the two pallets, with a first side door of a casing of the robotic cell being configured in an open configuration;

FIG. 4 is a front perspective view of the robotic cell shown in FIG. 3, with an end effector being removed;

FIG. 5 is a bottom plan view of the robotic cell shown in FIG. 4;

FIG. 6 is a top perspective view, enlarged, of a section of a robot support and transport frame of the robotic cell of FIG. 1, wherein a connector port casing lid is removed to expose a connector port chamber;

FIG. 7 is a top perspective view of a casing of the robotic cell of FIG. 1, wherein a rear door is configured in an open configuration;

FIG. 8 is a side elevation view of the casing shown in FIG. 7, wherein the first side door is removed;

FIG. 9 is a side elevation view of the casing shown in FIG. 7, wherein a second side door is configured in an open configuration;

FIG. 10 is a rear elevation view of the robotic cell of FIG. 3, configured in a first transport and storage configuration;

FIG. 11 is a front elevation view of the robotic cell of FIG. 10, wherein a conveyor attachment has been detached from the robot support and transport frame and lays on an upper wall thereof;

FIG. 12 is a side elevation view of the robotic cell of FIG. 10, contained in a transport and storage container;

FIG. 13 is a rear elevation view of the robotic cell of FIG. 10;

FIG. 14 is a front elevation view of the robotic cell of FIG. 10;

FIG. 15 is a top plan view of the robotic cell of FIG. 10;

FIG. 16 is a rear elevation view of the robotic cell of FIG. 3, configured in a second transport and storage configuration;

FIG. 17 is a first side elevation view of the robotic cell of FIG. 16;

FIG. 18 is a second side elevation view of the robotic cell of FIG. 16, contained in a transport and storage container;

FIG. 19 is a front side elevation view of the robotic cell of FIG. 16;

FIG. 20 is a top plan view of the robotic cell of FIG. 16;

FIG. 21 is a rear elevation view of the robotic cell configured in the first transport and storage configuration shown in FIG. 10, having a conveyor section mounted to a front section of the support and transport frame of the robotic cell; and

FIG. 22 is a side elevation view of the robotic cell shown in FIG. 21.

It will be noted that throughout the appended drawings, like features are identified by like reference numerals.

### DETAILED DESCRIPTION

Moreover, although the embodiments of the robotic cell assembly, a robotic cell, and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the robotic cell assembly and the robotic cell, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

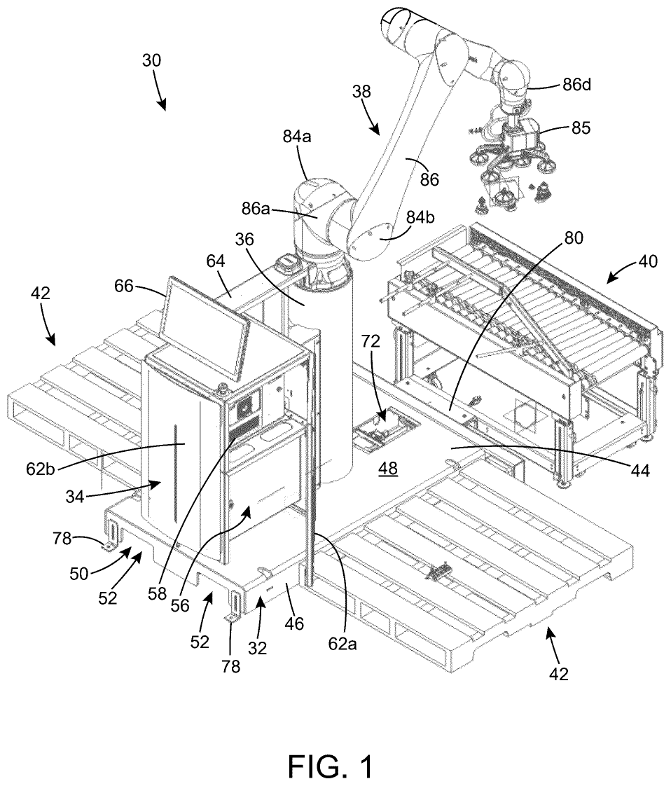

Referring now to FIG. 1, there is shown an embodiment of a robotic cell 30, in accordance with an embodiment. The robotic cell 30 includes a robot support and transport frame 32, a casing 34 mounted to the robot support and transport frame 32 and defining a control chamber 56, a robot base 36 mounted to the robot support and transport frame 32, and a robot 38 mounted to the robot base 36 and extending therefrom. The casing 34 and the robot base 36 protrude upwardly from the robot support and transport frame 32.

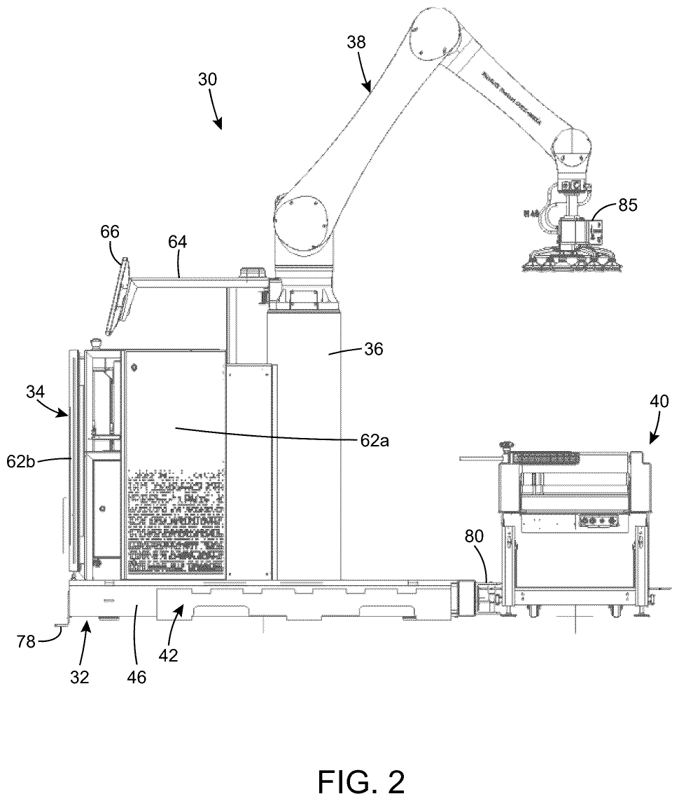

In the non-limitative embodiment shown in FIGS. 1 and 2, the robotic cell 30 is shown in combination with a conveyor section 40, mounted forwardly to the robotic cell 30, and two pallets 42, one on each side of the robotic cell 30.

In this non-limitative embodiment, the robotic cell 30 is a group/palletizing robot, wherein the robot 38 is configured to pick items from a pickup location such as the conveyor section 40 and the transfer the picked items to a grouping station, such as the two pallets 42 shown. The items can be released directly onto the pallets 42 or within boxes located on the pallets 42. It is appreciated that the pickup location can differ from the conveyor section 40 shown and the grouping section can also differ from the pallets 42 and can be any other suitable supporting surface to facilitate transportation, or further material handling, such as a skid, cardboard sheet, plastic sheet or metal sheet or combinations thereof.

It is also appreciated that the robot 38 of the robotic cell 30 can be used to perform other tasks than grouping items such as case packing, item sorting, or any alternative material handling.

Furthermore, in the non-limitative embodiment shown, the robot 38 is a collaborative robot. However, it is appreciated that the robot 38 can be of another type, shape or configuration.

It is also appreciated that the robotic cell 30 can be used with a large variety of conveyor configurations or other means of infeed, which can vary greatly from the one shown in FIGS. 1 and 2.

In an embodiment, the robot support and transport frame 32 supports directly or indirectly all the other components of the robotic cell 30. As will be described in more details below, the robotic cell 30 can be displaceable as a single unit from one location to another by displacing the robot support and transport frame 32.

In the embodiment shown, the robot support and transport frame 32 is substantially rectangular in shape. It includes a carrier floor 44 (which is an upper wall of the frame 32 in the non-limitative embodiment shown), which is substantially planar, and peripheral walls 46, extending downwardly from the carrier floor 44. The carrier floor 44 of the robot support and transport frame 32 defines an upper surface 48. The casing 34 and the robot base 36 protrude upwardly from the upper surface 48 of the carrier floor 44. The peripheral walls 46 extend downwardly from the carrier floor 44 to space apart the carrier floor 44 from a floor onto which the robotic cell 30 is supported. In an embodiment, to ease transport and displacement of the robotic cell 30, as a single unit, forklift tines are insertable in a spacing 50 defined between the carrier floor 44 and the floor.

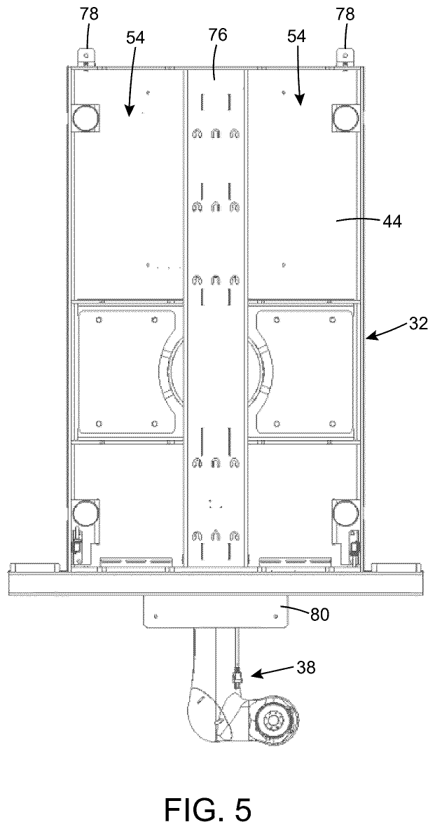

In the non-limitative embodiment shown, the peripheral wall 46 defines two spaced-apart forktine insertion recesses 52 providing access to forklift fork receiving channels 54 (FIG. 5), defined by the robot support and transport frame (not shown) 32. The forklift tines of a forklift are insertable and receivable in the forklift fork receiving channels 54 through the forktine insertion recesses 52 defined in the peripheral walls 46. In the embodiment shown, the forktine insertion recesses 52 are defined in a rear one of the peripheral walls 46. However, it is appreciated that they can be defined anywhere along the peripheral walls 46. Furthermore, the robotic cell 30 can be free of forktine insertion recesses 52. In alternative embodiment (not shown), the robotic cell 30 can include other means for transporting the robotic cell 30 as a single unit, such as wheels, skid plates, and the like. In some implementations, they are mounted to the robot support and transport frame 32.

It is appreciated that the shape and the configuration of the robot support and transport frame 32 can differ from the one shown in the Figures.

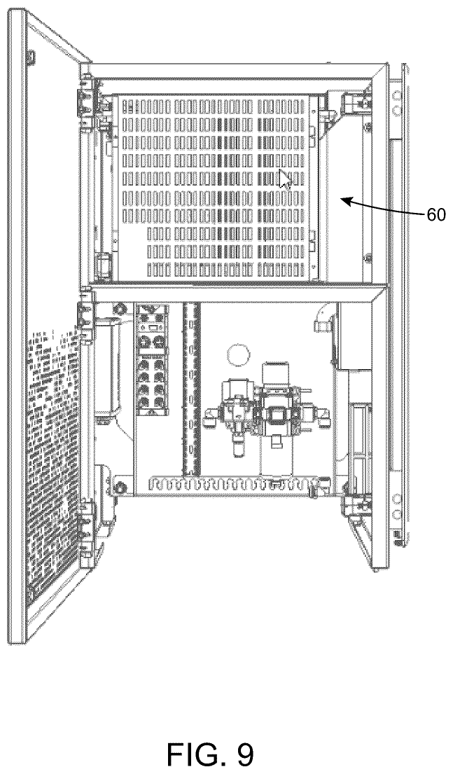

The control chamber 56 defined inside the casing 34 is configured to receive a control unit 58 and an electric panel 60 (FIG. 9) of the robotic cell 30. The control unit 58 can include a controller and/or a computer. As will be described in more details below, the robot 38 is operatively connected to the control unit 58.

In the embodiment shown, the casing has three pivotable and detachable door panels 62a, 62b, 62c to provide access to the control unit 58 and the electric panel 60, located inside the control chamber 56.

It is appreciated that the shape and the configuration of the casing 34 can differ from the one shown in the Figures.

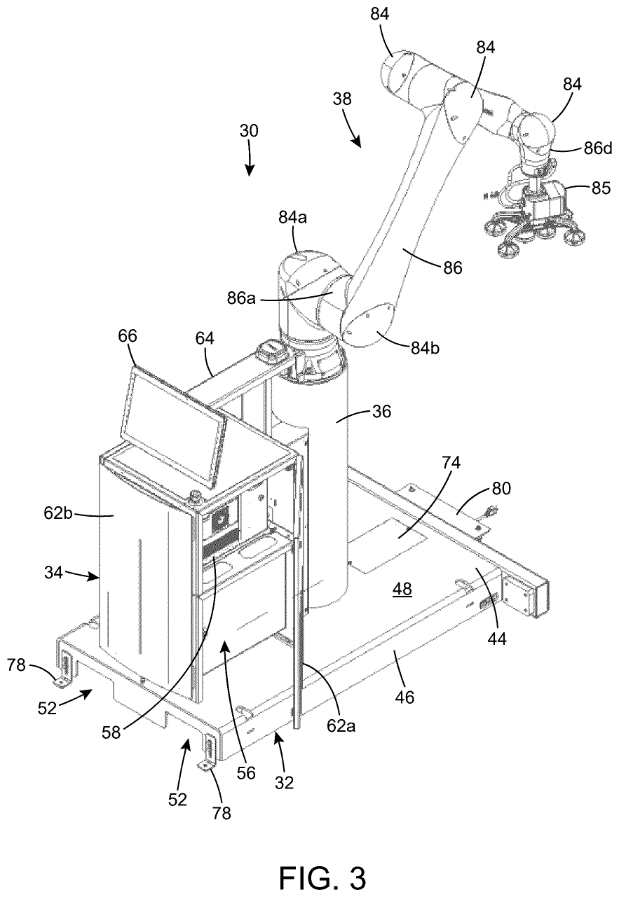

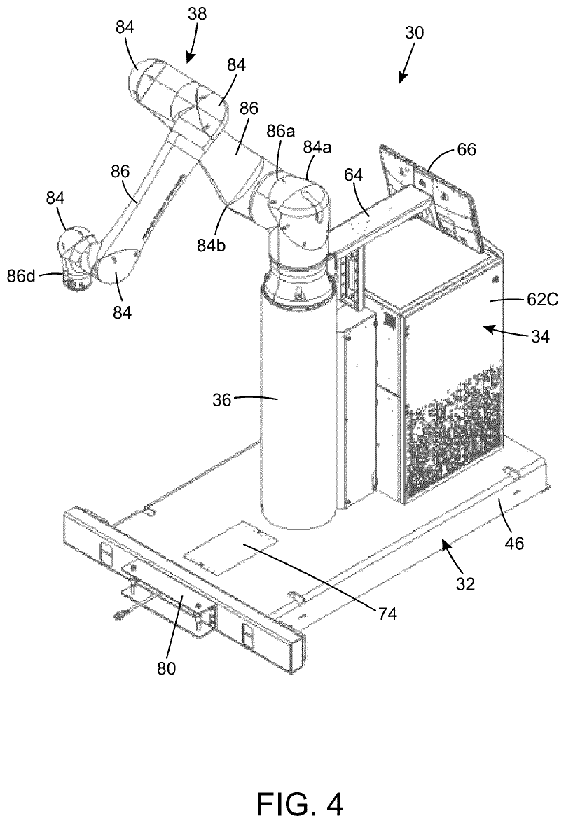

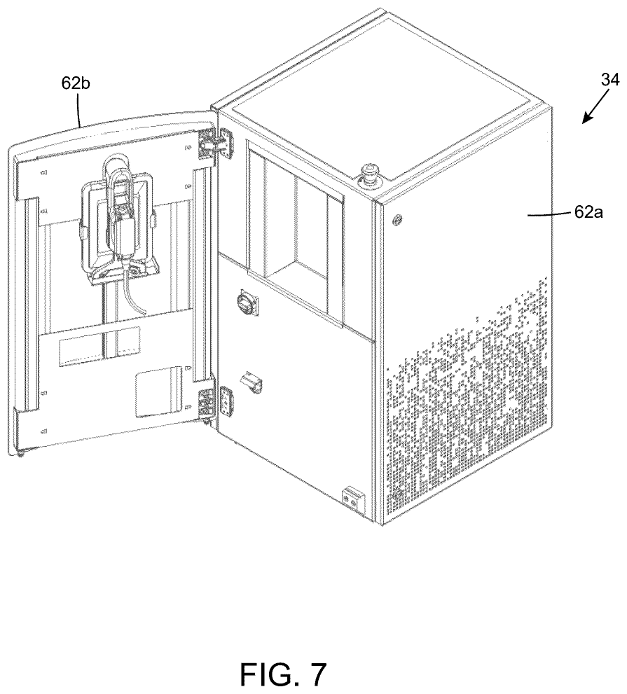

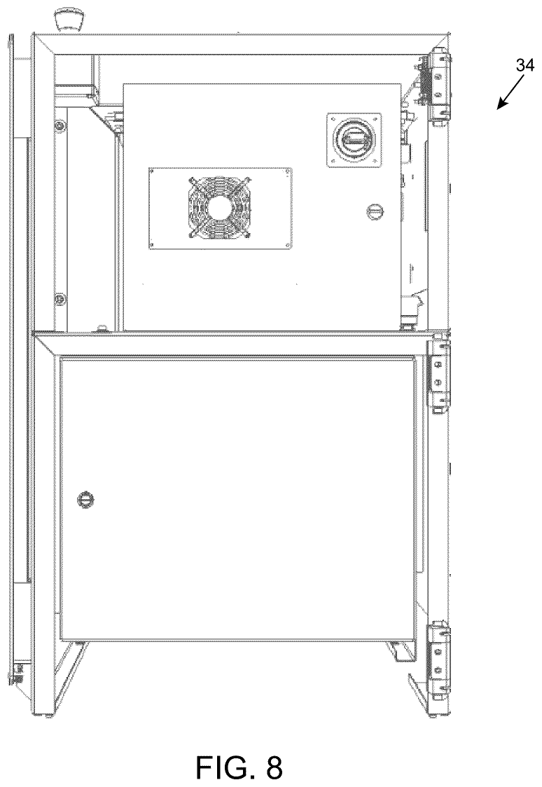

In FIGS. 1 and 3, a first side door panel 62a is configured in an open configuration while in FIG. 2, it is configured in a closed configuration. In FIG. 8, the first side door panel 62a is removed. In FIG. 7, a rear door panel 62b is configured in the open configuration, while in FIGS. 1 to 3, it is configured in the closed configuration. In FIG. 9, a second side door panel 62c is configured in a closed configuration, while in FIG. 4, it is configured in the closed configuration.

The robotic cell 30 also includes an HMI (human-machine interface) support 64 mounted to the casing 34 and/or the robot support and transport frame 32 and protruding upwardly therefrom. It is appreciated that the shape and the configuration of the HMI support 64 shown in the Figures.

The robotic cell 30 can further include a human-machine interface (HMI) 66 mounted to the HMI support 64. In the embodiment shown in the figures, the HMI 66 is embodied by a touch screen. However, it is appreciated that it can include more than one screen, a keyboard, a joystick, a mouse, and the like.

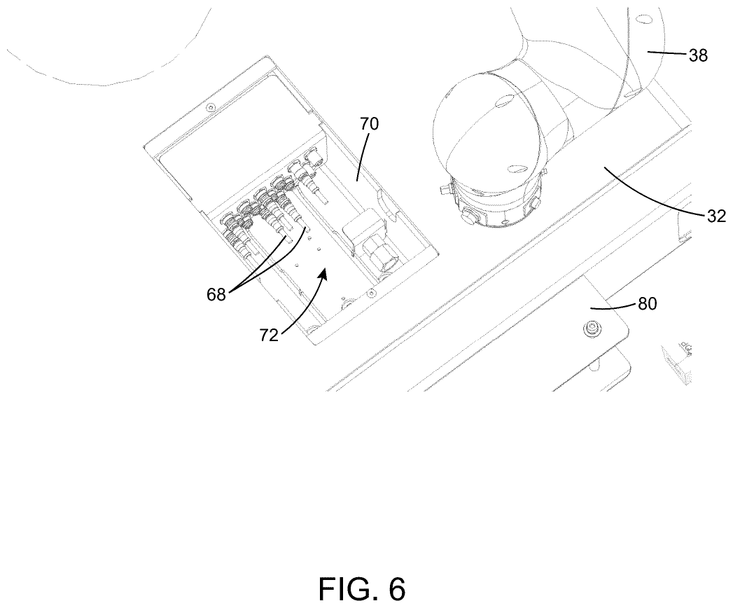

Referring now to FIG. 6, there is shown that the robotic cell 30 also includes a plurality of connector ports 68 mounted to the robot support and transport frame 32. However, it is appreciated that, in an alternative embodiment (not shown), the connector ports 68 can be mounted to the casing 34. In the non-limitative embodiment shown, the robot support and transport frame 32 includes a connector port casing 70 defining a connector port chamber 72, wherein the connector ports 68 are contained at least partially inside and accessible from the connector port chamber 72. In FIG. 6, a connector port casing lid 74 of the connector port casing 70 has been removed to show the connector ports 68. Referring back to FIGS. 3 and 4, the lid 74 is shown in a closed configuration, defines a portion of the carrier floor 44 of the robot support and transport frame 32, and prevents access to the connector ports 68. Therefore, the robotic cell 30 can be shipped and transported with most or all cables pre-installed and connected by a robotic cell manufacturer. Therefore, the requirement for specialized workforce for cable installation and commission on-site may be avoided.

It is appreciated that, in an alternative embodiment (not shown), the robotic cell 30 can include only one or at least one connector port 68 mounted to the robot support and transport frame 32. In some non-limitative embodiments, the robotic cell 30 also includes only one connector port 68, which is an electric port.

Referring now to FIG. 5, the robot support and transport frame 32 also includes a connector protection casing 76 defining a connector protection channel (not shown). In the embodiment shown, the connector protection casing 76 extends below and, more particularly, under the carrier floor 44 of the robot support and transport frame 32, between the front and the rear peripheral walls 46. The connector protection channel is configured to contain and protect a plurality of connectors, such as electrical, hydraulic, optical, and pneumatic connectors. The connectors extend at least partially inside the connector protection channel and at least one of connectors is connected to a respective one of the connector ports 68 at one end thereof. At the other end thereof, the connector can be operatively connected to the robot 38, the HMI 66, the control unit 58, and/or the electric panel 60.

For instance and without being limitative, the connectors can include electrical wires & cables, optical cables, and pneumatic or hydraulic tubing, to supply electricity, light signals, air, and/or liquid to the robotic cell 30, such as to the robot 38, the HMI 66, the control unit 58, and the electric panel 60. Similarly, the connector ports 68 can an be electrical port (including Ethernet/USB/Serial ports and the like), pneumatic port, and/or a hydraulic port, to which an electric supply, a light source, a pneumatic supply, and/or a hydraulic supply can be operatively connected to supply the connectors.

As shown in FIGS. 3 and 5, the robot support and transport frame 32 also includes floor anchors 78 to secure the robotic cell 30 to the floor at a selected location, via the robot support and transport frame 32. It is appreciated that the shape, the configuration, and the number of floor anchors 78 can vary from the embodiment shown.

Referring to FIGS. 1, 2, and 4, there is shown that the robot support and transport frame can also includes a conveyor attachment 80 engageable with the conveyor section 40 to prevent relative displacement between the conveyor and the robotic cell 30 and ease configuration and installation. It is appreciated that the shape, the configuration, and the number of the conveyor attachment 80 can vary from the embodiment shown.

Once the conveyor section 40 is detached from the conveyor attachment 80, the floor anchors 78 are unsecured from the floor, and the electric supply, light source, pneumatic supply, and/or hydraulic supply are disengaged from the connector ports 68, the entire robotic cell 30 can be transported from a first location to a second location. For instance, a forklift can insert its forktines into the forklift fork receiving channels 54 through the forktine insertion recesses 52, lift the robotic cell 30, and displace it to the second location, spaced-apart from the first location, as a single unit.

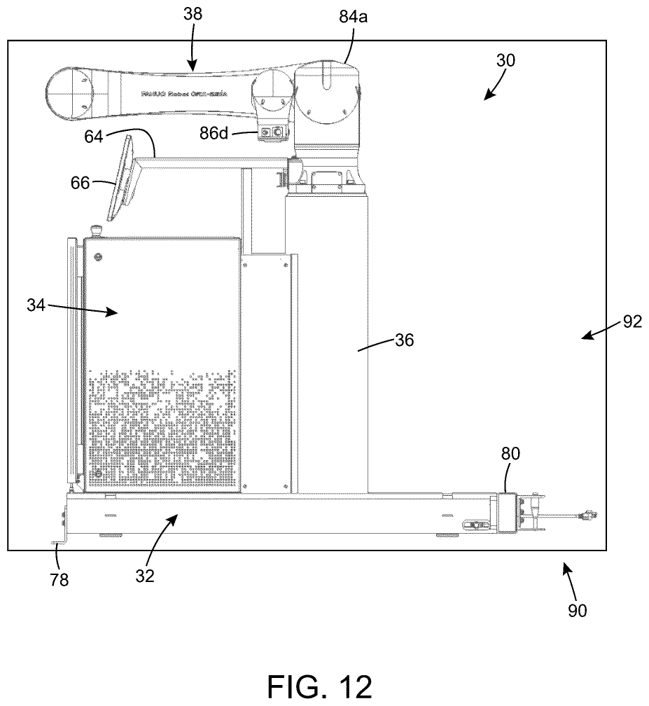

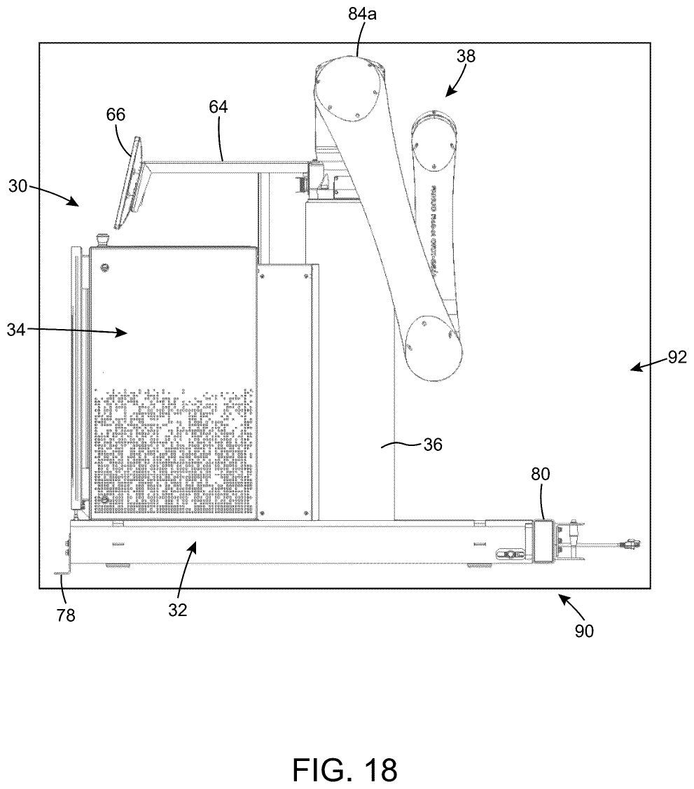

Similarly, the robotic cell 30 can be stored and transport into a transport and storage container 90 (FIGS. 12 and 18) defining a storage space 92. In an embodiment, the transport and storage container 90 has a width and a height, each one being shorter than about 10 ft and, in a particular embodiment, shorter than about 8 ft. In an embodiment, a length of the transport and storage container 90 is also shorter than about 10 ft and, in a particular embodiment, shorter than about 8 ft. The robotic cell 30 can be configured in a compacted storage configuration (also referred to as a transport and storage configuration) wherein it entirely be contained inside the storage space.

Referring back to FIGS. 3 and 4, in the non-limitative embodiment shown, the robot 38 includes an arm with a plurality of arm segments 86 connected by joints 84. In the embodiment shown in FIG. 4, an end effector 85 (FIGS. 1 to 3) detachably securable to a distal arm segment 86d has been removed, i.e. the last arm segment, considering that the one mounted to the robot base 36 is a proximal/first arm segment. A first one of the joints 84, starting from the robot base 36, is shoulder joint 84a. The configuration of the robot 38 can modified by pivoting the arm segments 86 about the joints 84. Therefore, the total dimensions—or a volume (along the x, y, and z axes) of the robot 38 can be modified. For transport and storage, the volume of the robot 38 can be minimized, at least reduced along at least one of the three axes. In an embodiment, a height of the robot 38 is minimized by folding the robot arm about the joints 84 in a manner such that the shoulder joint 84a is amongst the highest components of the robot 38.

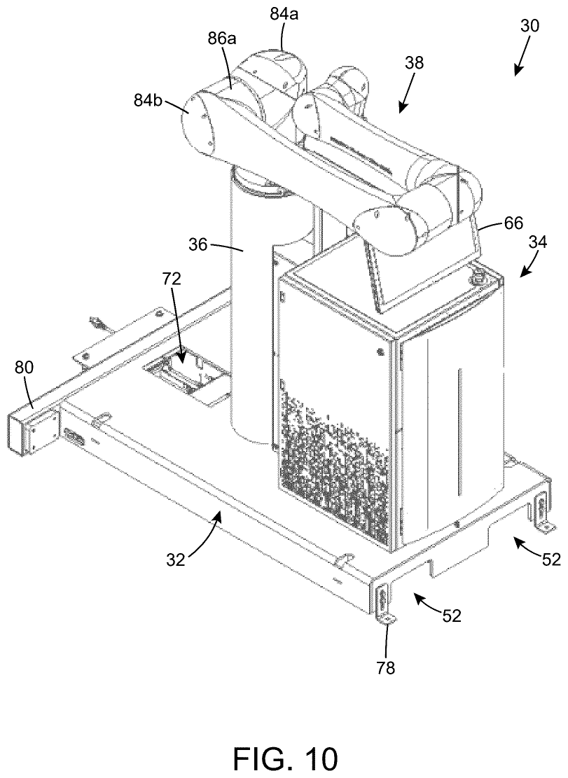

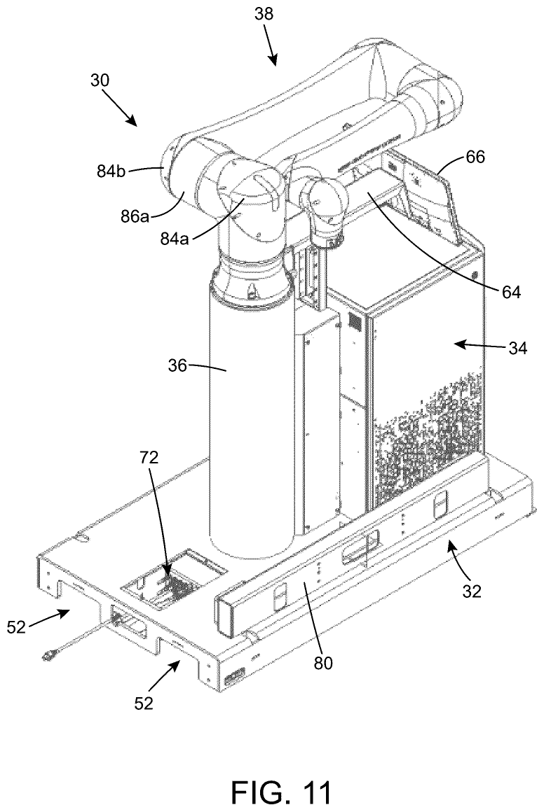

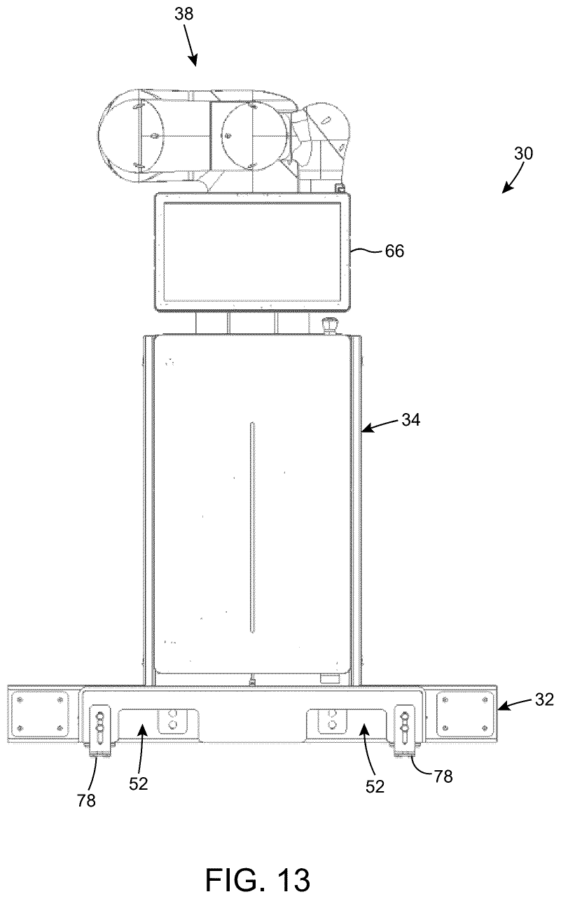

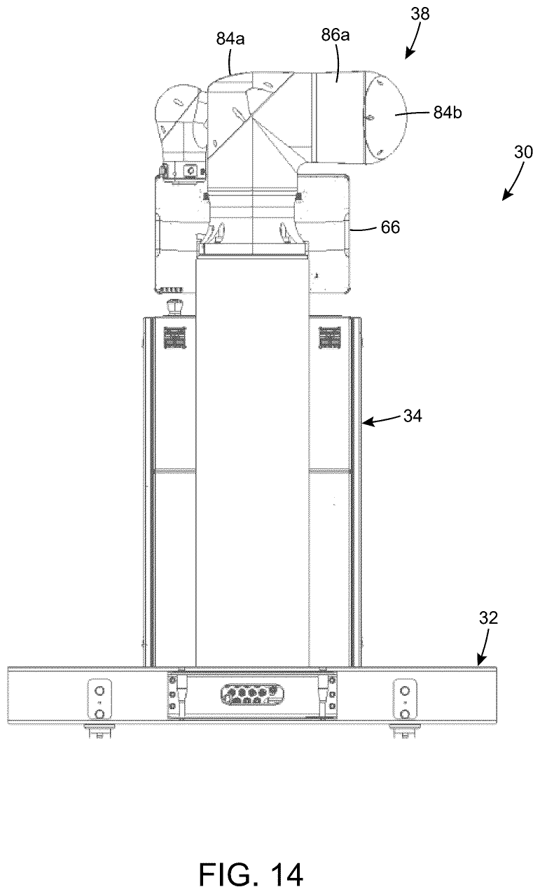

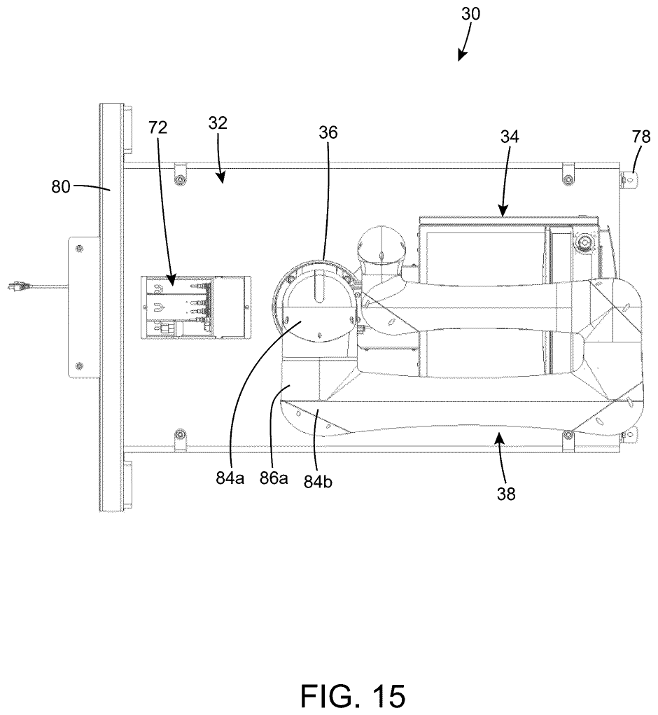

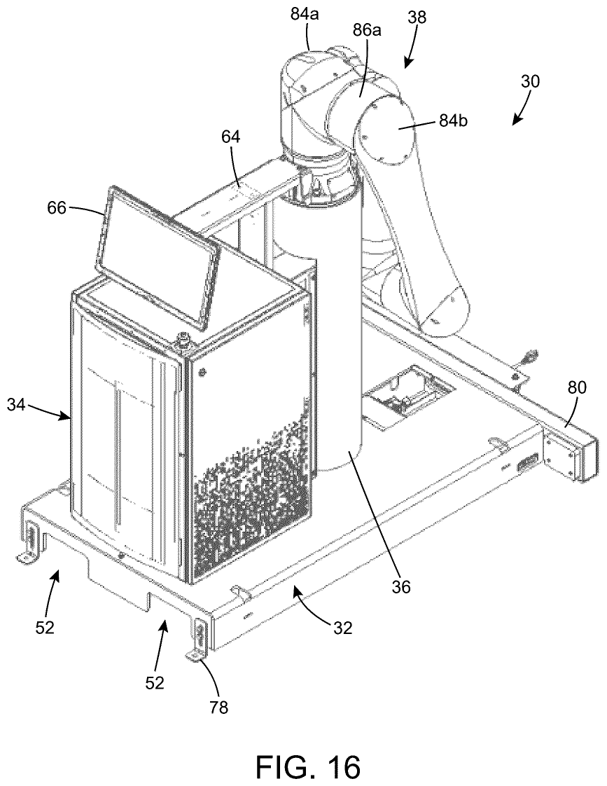

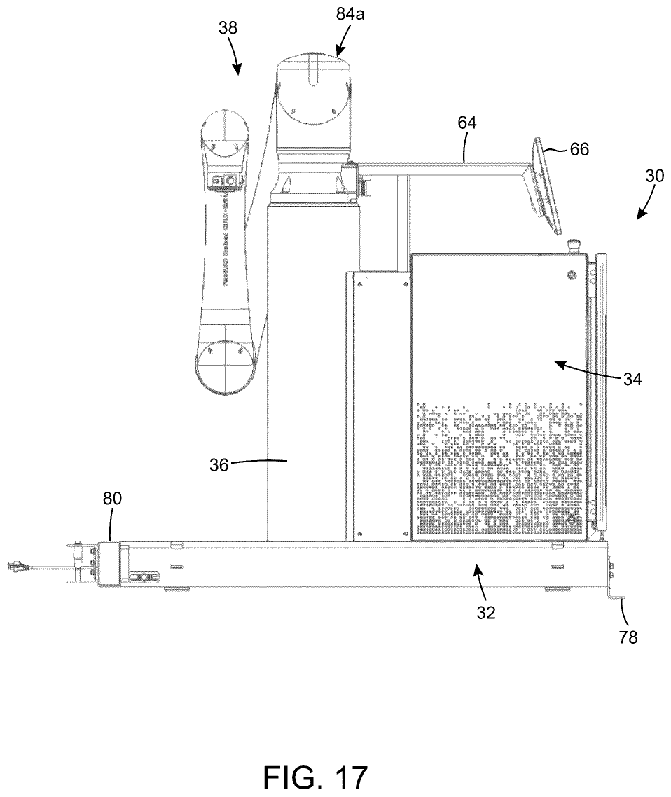

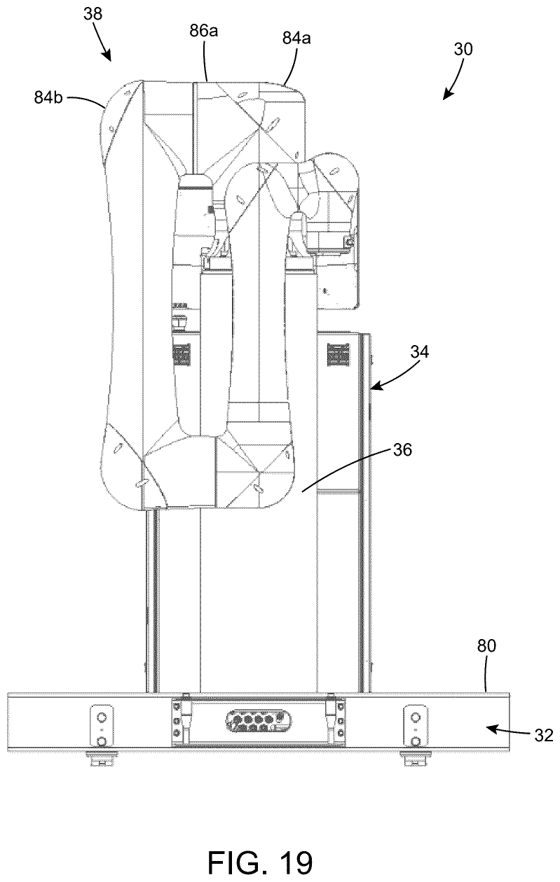

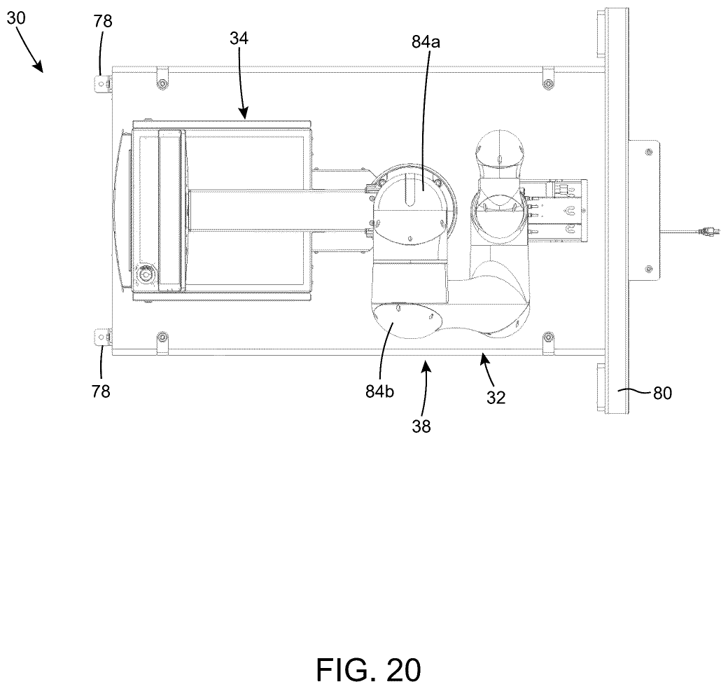

FIGS. 10 to 15 show the robot 38 being configured in a first compacted storage configuration and FIGS. 16 to 22 being configured in a second compacted storage configuration for storage and transportation.

In both compacted storage configurations, the shoulder joint 84a is amongst the highest components of the robot 38, at a substantially a same height than subsequent one of the arm segments 86 and an elbow joint 84b.

In the first compacted storage configuration, all the joints 84 and the arm segments 86 extending in between are substantially at a same height, which is the apex of the robot 38 in this configuration. In the first compacted storage configuration, the shoulder joint 84a, the elbow joint 84b, and the arm segment 86a extending in between are substantially at a same height, which is the apex of the robot 38 in this configuration.

Furthermore, in some implementations, when contained in the storage space 92 of the transport and storage container 90, the highest component(s) of the robot 38, including the shoulder joint 84a, is (are) the highest component(s) of the robotic cell 30.

For storing and transporting the robotic cell 30, the robot arm of the robot 38 can be folded one of the compacted storage configuration(s) wherein the shoulder joint 84a of the robot arm is at least one of highest component of the robot 38. Then, the robotic cell 30 with the robot 38 in the compacted storage configuration can be inserted inside the storage space 92 defined in the transport and storage container 90 and the transport and storage container 90 can be closed.

Thus, when stored inside the transport and storage container 90 for storage and transportation, the robotic cell 30 is in an assembled and almost ready to use configuration. In the assembled configuration:
the casing 34 and the robot base 36 are mounted to the robot support and transport frame 32,
the robot 38 is secured to the robot base 36 and configured in a compacted storage configuration,
the HMI support 64 is mounted to the casing 34 and/or the robot support and transport frame 32 and/or the robot base 36,
the control unit 58 and the electric panel 60 are contained in the control chamber 56 of the casing 34, the robot 38 is operatively connected to the control unit 58 and/or the electric panel 60, and
the connector ports 68 are mounted to one of the robot support and transport frame 32 and the casing 34 and ready to be in communication with at least one of the robot 38, the control unit 58, and the electric panel 60.

For instance, the connection between the connector ports 68 and the at least one of the robot 38, the control unit 58, and the electric panel 60 can be provided by the connectors, which can be electrical wires & cables, optical cables, and pneumatic or hydraulic tubing. In an embodiment, the connectors are connected to the connector ports 68 when the robotic cell 30 is contained in the storage space 92 of the transport and storage container 90.

The compacted storage configuration of the robot 38 can be the first or the second compacted storage configurations shown in the FIGS. 10 to 15 and FIGS. 16 to 20 respectively or any alternative thereof.

In some embodiments, the robotic cell 30 contained in the storage space 92 of the transport and storage container 90 can further include the HMI 66 mounted to the HMI support 64 and operatively connected to the control unit 58 and/or the electric panel 60. Furthermore, it is appreciated that, if detached from the HMI support 64, the HMI 66 can be contained in the storage space 92 simultaneously with the robotic cell 30 in the compacted storage configuration for storage and transport.

In some embodiments, the robotic cell 30 contained in the storage space 92 can further include the connector protection casing 76, defining the connector protection channel and containing/surrounding at least a section of the connectors.

In some embodiments, the conveyor attachment 80 and/or the floor anchors 78 are already provided on the robot support and transport frame 32 when the robotic cell 30 contained in the storage space 92.

In some embodiments, the end effector 85 can be mounted to the distal arm segment 86d when the robotic cell 30 is contained and stored in the storage space 92. In another embodiment, the end effector 85 can be detached from the distal arm segment 86d when the robotic cell 30 is contained and stored in the storage space 92. Furthermore, one or more end effectors 85 can be contained in the storage space 92 simultaneously with the robotic cell 30 in the compacted storage configuration for storage and transport.

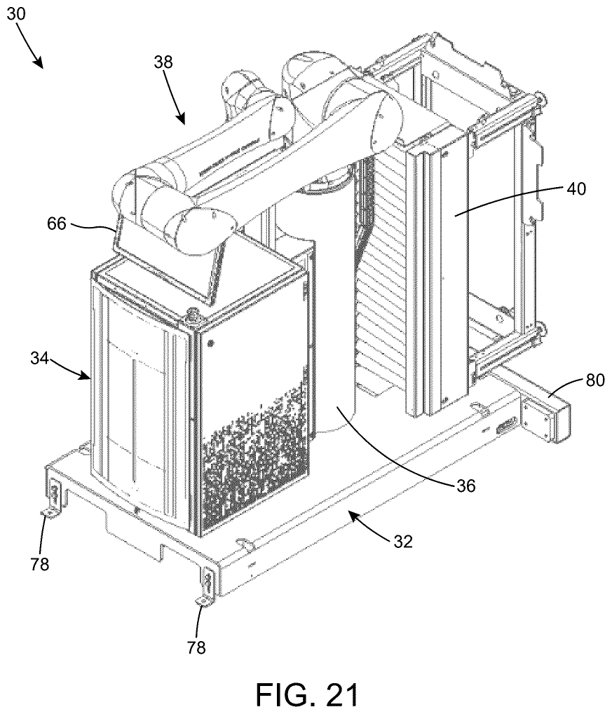

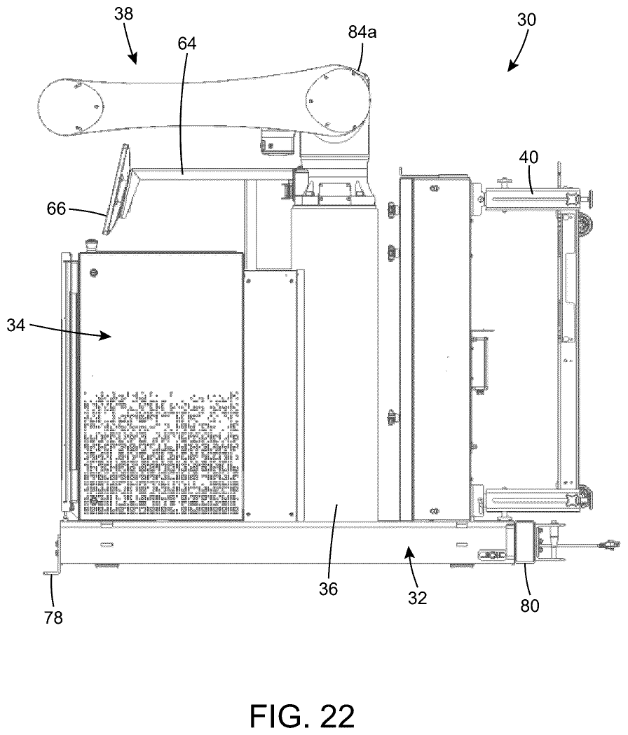

As shown in FIGS. 21 and 22, one conveyor section 40 can be contained and stored in the storage space 92 simultaneously with the robotic cell 30 in the first compacted storage configuration for storage and transport. It is appreciated that more than one conveyor section 40 can be contained and stored simultaneously in the storage space.

Thus, once close to the selected location, the robotic cell 30 can be removed from the transport and storage container 90, displaced to the selected location, as a single unit by moving the robot support and transport frame 32, using a forklift, for instance.

Once at the selected location, the robot support and transport frame 32 can be anchored to the floor using the floor anchors 78 and/or a conveyor section 40 can be secured to the robot support and transport frame 32 via the conveyor attachment 80.

The arm of the robot 38 can be unfolded from the compacted storage configuration to an operative configuration. If required, an end-effector can be mounted to a distal one of the arm segments 86.

An electric supply, a light source (for optical communication), a pneumatic supply, and/or a hydraulic supply can be connected to the connector ports 68 to supply the robot 38, the control unit 58 and/or the electric panel 60 via the connectors.

If required, the HMI can be mounted to the HMI support 64 and connected to the control unit 58 and/or the electric panel 60, limiting the involvement of a specialized workforce for installation and commissioning. Thereby, reducing delays and potential complications during on-site installation.

For displacing the robotic cell 30 from a first location to a second location, the robot support and transport frame 32 can be lifted. The robot support and transport frame 32 has: the casing 34 and the robot base 36 mounted thereto, the robot 38 secured to the robot base 36, the HMI support 64 and the connector ports 68 mounted to at least one of the casing 34 and the robot support and transport frame 32, the control unit 58 and the electric panel 60 contained in the control chamber 56 of the casing 34, connectors extending between the connector ports 68 and at least one of the robot 38, the control unit 58, and the electric panel 60, the robot 38 being operatively connected to at least one of the control unit 58 and the electric panel 60 and the connector ports 68 being ready to be in communication with at least one of the robot 38, the control unit 58, and the electric panel 60. Then, the lifted robot support and transport frame 32 can be displaced to and set down at the second location.

In an embodiment, before lifting the robot support and transport frame 32, the conveyor 40 engaged with the robot support and transport frame 32 can be detached and/or the robot support and transport frame 32 can be unsecured/detached from the floor.

Lifting of the robot support and transport frame 32 can be carried out by inserting forklift tines in a spacing defined between the carrier floor 44 of the robot support and transport frame 32 and the floor and raising the forklift tines to lift the robot support and transport frame 32.

Thus, the robotic cell 30, being storable/displaceable, as a single unit, in the assembled configuration, can be quickly installed or displaced, and ready to perform repetitive tasks.

Therefore, the robotic cell 30 described above is relatively versatile in comparison with conventional industrial cells which are designed and manufactured for specific use. Specialized workforce need for installation and commissioning is still reduced, in comparison with installation and commissioning of conventional industrial robotic cells. Specialized workforce need for modification/adaptation is also limited, thereby reducing the associated costs. The robotic cell assembly can be transported, as a single unit, in a relatively small container.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. Meanings of technical and scientific terms used herein are to be commonly understood as by one of ordinary skill in the art to which the invention belongs, unless otherwise defined.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element. It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It will be appreciated that the methods described herein may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A robotic cell assembly comprising:
a transport and storage container defining a storage space; and
a robotic cell contained in the storage space, the robotic cell comprising:
a robot support and transport frame having a carrier floor;
a casing mounted to the robot support and transport frame and defining a control chamber;
a control unit contained in the control chamber;
an electric panel contained in the control chamber;
a robot base mounted to the robot support and transport frame and protruding upwardly therefrom;
a robot mounted to the robot base and operatively connected to the control unit; and
at least one connector port mounted to one of the robot support and transport frame and the casing and each one being in communication with at least one of the robot, the control unit, and the electric panel.

2. The robotic cell assembly of claim 1, wherein the robot comprises a robot arm with a shoulder joint and the shoulder joint is at least one of highest component of the robot inside the storage space.

3. The robotic cell assembly of claim 2, wherein the shoulder joint is at least one of the highest component of the robotic cell inside the storage space.

4. The robotic cell assembly of claim 1, wherein the carrier floor of the robot support and transport frame defines an upper surface and the robot support and transport frame further includes peripheral walls to space apart the carrier floor from a floor supporting the robot support and transport frame, wherein forklift tines are insertable in a spacing defined between the carrier floor and the floor and wherein the casing and the robot base protrude upwardly from the upper surface of the carrier floor and wherein the robot support and transport frame defines forklift-fork receiving channels with the forklift tines being receivable therein.

5. The robotic cell assembly of claim 1, wherein the at least one connector port of the robotic cell comprises a plurality of connector ports and the robot support and transport frame comprises at least one connector protection casing defining a connector protection channel and the robotic cell further comprises at least one electrical, hydraulic, optical, and/or pneumatic connectors extending at least partially inside the connector protection channel, at least one of the at least one electrical, hydraulic, optical, and pneumatic connectors being connected to a respective one of the connector ports.

6. The robotic cell assembly of claim 5, wherein the at least one connector protection casing extends below the carrier floor of the robot support and transport frame.

7. The robotic cell assembly of claim 5, wherein the robot support and transport frame comprises a connector port casing defining a connector port chamber, wherein the connector ports are contained at least partially inside and accessible from the connector port chamber.

8. The robotic cell assembly of claim 1, wherein the robot support and transport frame comprises a conveyor attachment engageable with a conveyor to prevent relative displacement between the conveyor and the robotic cell.

9. The robotic cell assembly of claim 1, wherein the robot support and transport frame comprises floor anchors.

10. The robotic cell assembly of claim 1, wherein the robotic cell further comprises a HMI support mounted to at least one of the casing and the robot support and transport frame and the robotic cell further comprises a human-machine interface (HMI) mounted to the HMI support.

11. A robotic cell comprising:
a robot support and transport frame having a carrier floor;
a casing mounted to the robot support and transport frame and defining a control chamber;
a control unit contained in the control chamber;
an electric panel contained in the control chamber;
a robot base mounted to the robot support and transport frame and protruding upwardly therefrom;
a robot mounted to the robot base and operatively connected to the control unit; and
at least one connector port mounted to one of the robot support and transport frame and the casing and each one being in communication with at least one of the robot, the control unit, and the electric panel,
wherein the robotic cell is displaceable as a single unit from one location to another by displacing the robot support and transport frame.

12. The robotic cell of claim 11, wherein the carrier floor of the robot support and transport frame defines an upper surface and the robot support and transport frame further includes peripheral walls to space apart the carrier floor from a floor supporting the robot support and transport frame, wherein forklift tines are insertable in a spacing defined between the carrier floor and the floor and wherein the casing and the robot base protrude upwardly from the upper surface of the carrier floor.

13. The robotic cell of claim 12, wherein the robot support and transport frame defines forklift-fork receiving channels with the forklift tines being receivable therein.

14. The robotic cell of claim 11, wherein the at least one connector port of the robotic cell comprises a plurality of connector ports and the robot support and transport frame comprises at least one connector protection casing defining a connector protection channel and the robotic cell further comprises at least one electrical, hydraulic, optical, and/or pneumatic connectors extending at least partially inside the connector protection channel, at least one of the at least one electrical, hydraulic, optical, and pneumatic connectors being connected to a respective one of the connector ports and wherein the at least one connector protection casing extends below the carrier floor of the robot support and transport frame.

15. The robotic cell of claim 14, wherein the robot support and transport frame comprises a connector port casing defining a connector port chamber, wherein the connector ports are contained at least partially inside and accessible from the connector port chamber.

16. The robotic cell of claim 11, wherein the robot support and transport frame comprises:
a conveyor attachment engageable with a conveyor to prevent relative displacement between the conveyor and the robotic cell; and
floor anchors.

17. The robotic cell of claim 11, wherein the robotic cell further comprises a HMI support mounted to at least one of the casing and the robot support and transport frame and the robotic cell further comprises a human-machine interface (HMI) mounted to the HMI support.

18. A method for storing and transporting the robotic cell as claimed in claim 11, comprising:
folding a robot arm of the robot into a compacted storage configuration wherein a shoulder joint of the robot arm is at least one of highest component of the robot;
inserting the robotic cell with the robot in the compacted storage configuration inside a storage space defined in the transport and storage container; and
closing the transport and storage container.

19. A method for displacing the robotic cell as claimed in claim 11 from a first location to a second location, comprising:
at the first location, lifting the robot support and transport frame having the casing and the robot base mounted thereto, the robot being secured to the robot base, the HMI support and the at least one connector port being mounted to at least one of the casing and the robot support and transport frame, the control unit and the electric panel be contained in the control chamber of the casing, connectors extending between the at least one connector port and at least one of the robot, the control unit, and the electric panel, the robot being operatively connected to at least one of the control unit and the electric panel and the at least one connector port being ready to be in communication with at least one of the robot, the control unit, and the electric panel; and
displacing the lifted robot support and transport frame the second location; and
setting down the lifted robot support and transport frame at the second location.

20. The method as claimed in claim 19 comprising, before lifting the robot support and transport frame, at least one of:
detaching a conveyor engaged with the robot support and transport frame; and
unsecuring the robot support and transport frame from the floor.
